(19) United States
(12) Patent Application Publication
(10) Pub. No.: US 2014/0225994 A1
(43) Pub. Date: Aug. 14, 2014

(54) THREE-DIMENSIONAL IMAGE ADJUSTING DEVICE AND METHOD THEREOF

(71) Applicant: Realtek Semiconductor Corporation, Hsinchu (TW)

(72) Inventor: Hsu-Jung TUNG, Zhubei City (TW)

(21) Appl. No.: 13/918,676

(22) Filed: Jun. 14, 2013

(30) Foreign Application Priority Data
Feb. 8, 2013 (TW) 102105058

(51) Int. Cl. H04N 13/04

(52) U.S. Cl. CPC H04N 13/0468
USPC 348/51

(57) ABSTRACT

A three-dimensional image adjusting device and a method thereof are provided. The three-dimensional image adjusting device has a three-dimensional image display used to produce a three-dimensional image with an image depth. The three-dimensional image display emits a first luminosity, A brightness detecting system detects and calculates the first luminosity to produce a first luminosity value. A visual depth detecting system defines a visual depth range according to the first luminosity value. An image processor adjusts the image depth of the three-dimensional image correspondingly according to the visual depth range. Therefore, when the first luminosity value increases, the visual depth range is increased correspondingly.

This application claims the benefit from the priority to Taiwan Patent Application No. 102105058 filed on Feb. 8, 2013, the disclosures of which are incorporated by reference herein in their entirety.

### CROSS-REFERENCES TO RELATED APPLICATIONS

Not applicable.

### BACKGROUND OF THE INVENTION

1. Field of the Invention

The present invention provides a three-dimensional image adjusting device and a method thereof.

2. Descriptions of the Related Art

For an ordinary person, the two eyes are spaced apart by a distance of about 65 mm as shown in FIG. 1. When the person is to watch an object, the thicknesses of the crystalline lenses 6 of the left eye and the right eye are accommodated to adjust the refractive power so that the two eyes are focused at a focal point 61 where the object is located. Meanwhile, respective view angles of the two eyes are adjusted to align with the object. When the object is located at a far distance, the differential angle between the view angles of the two eyes is relatively small, but as the distance from the object becomes smaller, the differential angle becomes larger. Images received by the two eyes respectively are then transmitted to the brain to form a three-dimensional (3D) image of the object that is perceived by the person. In other words, the changes in the thicknesses of the crystalline lenses of the two eyes and the view angle adjustment are carried out together during the process of forming a visual image.

The 3D displaying technology currently available gives a 3D effect by providing different images to the left eye and the right eye. In other words, only the horizontal parallax of the two eyes is used to produce the 3D effect, hut the mechanism of adjusting the crystal thickness of the eyeballs is ignored. Consequently, as shown in FIG. 2, a viewer who is viewing a 3D image will have two eyes focus on a screen 62 with a constant curvature of the crystalline lenses 60s; however, as the 3D image moves, the two eyes will adjust the view angles reflexively and continuously to track the focal point 61 of the 3D image. In this case, the curvature of the crystalline lenses 60 remains constant while the view angles of the eyeballs change continuously, which goes against the normal visual response characteristics of people's eyes. As a result, the brain is unable to smoothly process the information and the two eyes cannot coordinate well with each other, thus causing headaches and eye fatigue; this phenomenon is referred to in the medical field as a convergence-accommodative conflict. This phenomenon becomes more significant as the distance between the viewer and the 3D displaying screen becomes shorter.

There are two approaches commonly used to solve the aforesaid problem of the convergence-accommodation conflict. One approach is to alleviate the uncomfortable feelings of the two eyes by reducing the parallax effect between the two eyes. Although this can mitigate the problem of the convergence-accommodation conflict, the 3D effect is weakened.

The other approach to solve the problem of convergence-accommodation conflict is to change the structure of the display panel. That is, a multi-focal-plane display that can alleviate the fatigue of the eyes is developed so that it is unnecessary for the viewer to intentionally have his eyes focus on a certain point or a certain plane. In this way, the discomfort of the eyes when watching a 3D film can be eliminated because the viewer becomes able to freely adjust the curvature of the crystalline lenses. However, this kind of multi-focal-plane display has a high manufacturing cost, which makes it costly and restricted in use.

Accordingly, it is important to provide a 3D image adjusting device that allows the viewer to watch 3D images comfortably and a method thereof

### SUMMARY OF THE INVENTION

One objective of the present invention is to provide a three-dimensional image adjusting device,

Another objective of the present invention is to provide a method for adjusting a three-dimensional image.

The three-dimensional image adjusting device of the present invention comprises a three-dimensional image display, a brightness detecting system, a visual depth detecting system and an image processor. The three-dimensional image display produces a three-dimensional image with an image depth and emits a first luminosity. The brightness detecting system detects and calculates the first luminosity to produce a first luminosity value. The visual depth detecting system defines a visual depth range according to the first luminosity value. The image processor adjusts the image depth of the three-dimensional image correspondingly according to the visual depth range. When the first luminosity value increases, the visual depth range increases correspondingly.

The method for adjusting a three-dimensional image of the present invention comprises the following steps: (a) detecting and calculating a first luminosity of a three-dimensional image display to produce a first luminosity value; (b) defining a visual depth range according to the first luminosity value; and (c) adjusting an image depth of a three-dimensional image correspondingly according to the visual depth range.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view illustrating the changes in the thicknesses of the crystalline lenses and the differential angle between the viewing angle of a person's two eyes when the person is watching an object at a tar distance and a near distance respectively under normal circumstances;

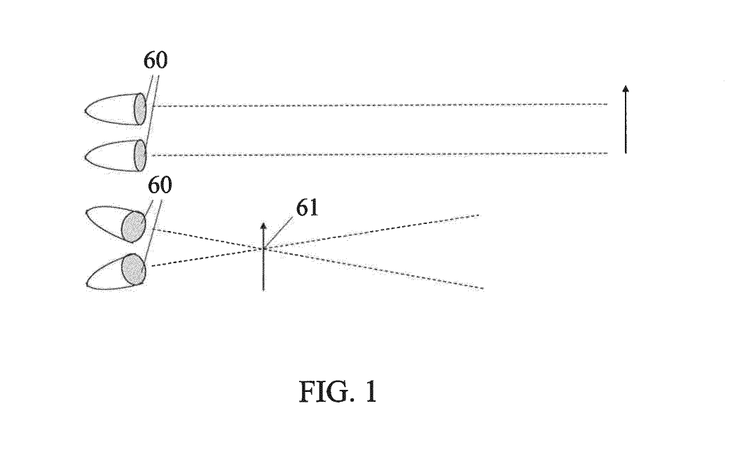

FIG. 2 is a schematic view illustrating the changes in the thicknesses of the crystalline lenses and the differential angle between the viewing angle of a person's two eyes when the person is watching a three-dimensional image at a far distance and a near distance respectively;

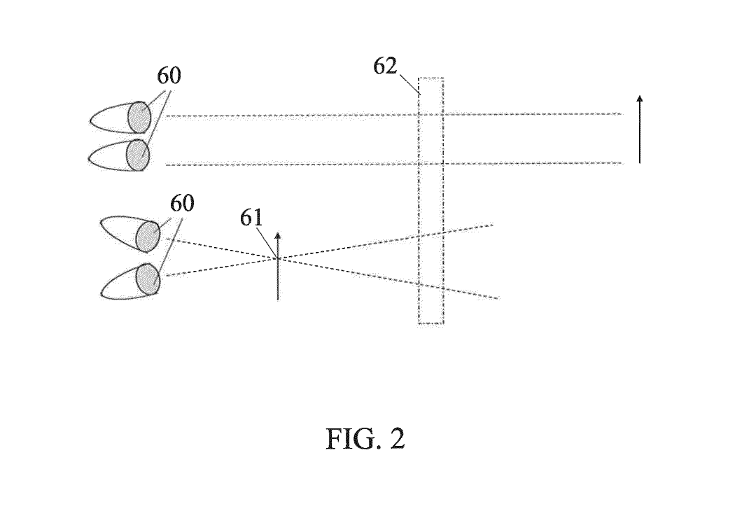

FIG. 3 is a schematic view of a three-dimensional image adjusting device according to an embodiment of the present invention;

FIG. 4 is a schematic view of a three-dimensional image adjusting device according to another embodiment of the present invention;

FIG. 5 is a flowchart diagram of a method for adjusting a three-dimensional image according to the present invention; and

FIG. 6 is a block diagram of a three-dimensional image adjusting device according to the present invention.

### DESCRIPTION OF THE PREFERRED EMBODIMENT

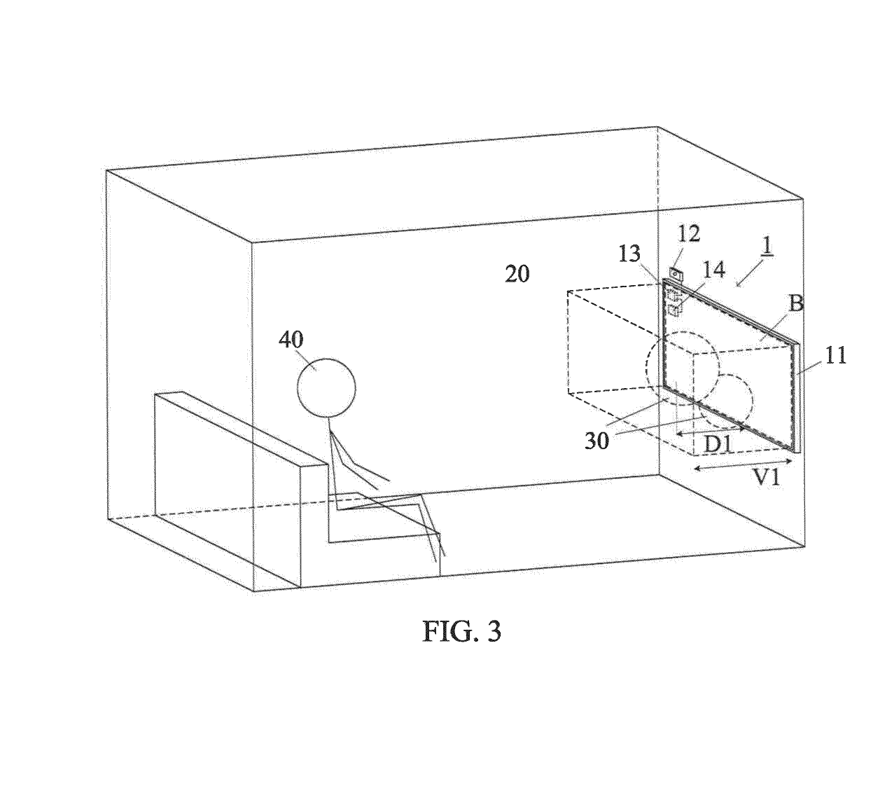

FIG. 3 is a schematic structural view of a three-dimensional image adjusting device 1 of the present invention. As shown, the three-dimensional image adjusting device 1 comprises a three-dimensional image display 11, a brightness detecting system 12, a visual depth detecting system 13 and an image processor 14.

The three-dimensional image display 11 (e.g., an LED display or an LCD display) provides an image to a viewer 40 so that the viewer 40 can view a three-dimensional image 30. The three-dimensional image display 11 emits a first luminosity B, and the resulting three-dimensional image 30 has an image depth D1. The brightness detecting system 12 detects and calculates the first luminosity B of the three-dimensional image display 11 to produce a first luminosity value B1. The visual depth detecting system 13 is adapted to define a visual depth range V1 by, for example, creating a corresponding table from medical average values or experiment statistics according to the first luminosity value B1 detected by the brightness detecting system 12. Finally, the image processor 14 can adjust the image depth D1 of the three-dimensional image 30 correspondingly according to the visual depth range V1. In this embodiment, the three-dimensional image 30 that has not been adjusted yet can be viewed as an initial three-dimensional image.

The three-dimensional image adjusting device 1 of the present invention obtains the first luminosity value B1 by detecting the first luminosity B of the three-dimensional image display 11, and defines the visual depth range V1 to adjust the image depth D1 of the three-dimensional image 30 (the initial three-dimensional image) correspondingly. In this way, the adjusted three-dimensional image 30 is always kept within the visual depth range V1, thus, easing the burden of the convergence-accommodation conflict in the viewer's eyes. For example, when the first luminosity value B1 obtained by the brightness detecting system 12 increases, the pupils of the viewer 40 contract initiatively to reduce the amount of the incident light. As a result, the range of the depth of field in which the viewer 40's eyes can see clearly is widened (i.e., the visual depth range V1 is widened). Accordingly, the image processor 14 may increase the image depth D1 to make the effect of the 3D image more significant. On the contrary, when the first luminosity value B1 is getting smaller, the pupils of the viewer 40 dilate initially. As a result, the range of the depth of field in which the viewer 40's eyes can see clearly is narrowed (i.e., the visual depth range V1 is narrowed). Accordingly, the image processor 14 needs to decrease the image depth D1.

In other words, the three-dimensional image adjusting device 1 of the present invention adjusts the 3D effect correspondingly by detecting the first luminosity value B1 of the first luminosity B of the three-dimensional image display 11. Thereby, the discomfort of the viewer 40 due to the convergence-accommodation conflict is reduced.

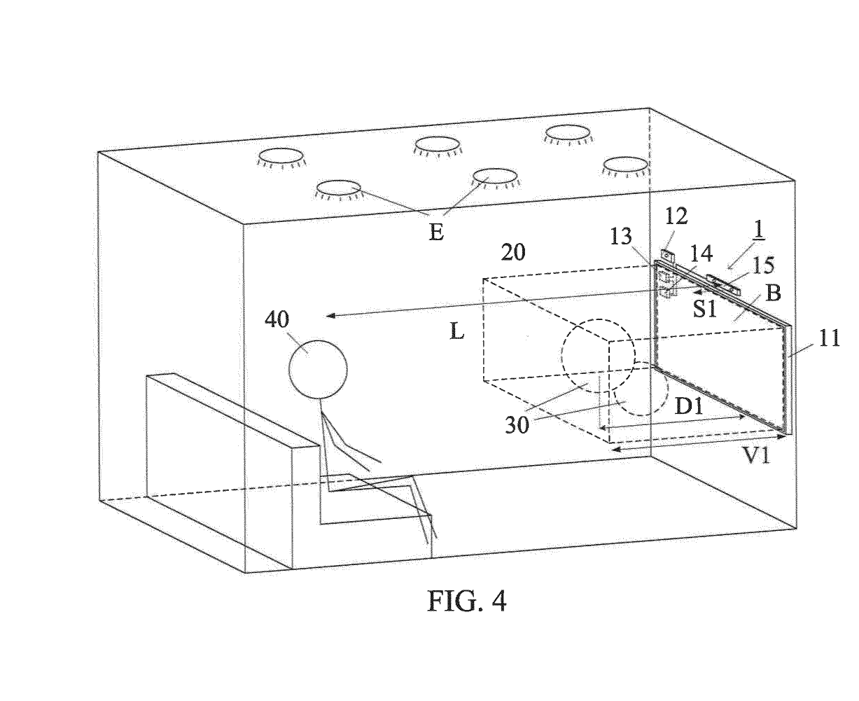

As shown in FIG. 4, in the preferred embodiment, the brightness detecting system 12 may further detect an environment luminosity E of the viewing environment 20 to produce a second luminosity value B2. Then, the visual depth detecting system 13 defines the visual depth range V1 according to both the first luminosity value B1 and the second luminosity value B2 to adjust the image depth D1 of the three-dimensional image 30 correspondingly.

The distance sensor 15 may be further provided to detect a viewing distance L between the viewer 40 and the three-dimensional image display 11. The distance sensor 15 can detect the viewing distance L between at least one viewer 40 and the three-dimensional image display 11 by emitting a light source signal S1 or in other ways, and provide the viewing distance L to the image processor 14. The image processor 14 then adjusts the image depth D1 of the three-dimensional image 30 correspondingly through analysis and calculation according to the viewing distance L, the first luminosity value B1 and the second luminosity value B2.

FIG. 4 illustrates that the distance sensor 15 is disposed adjacently above the three-dimensional image display 11 to detect the viewing distance L between the viewer 40 and the three-dimensional image display 11. However, this is not intended to limit the present invention. In other words, the distance sensor 15 may also be disposed at the periphery of the three-dimensional image display 11 or be disposed adjacently at one side thereof, as long as the viewing distance L can be detected by the distance sensor 15. In this embodiment, the distance sensor 15 may be implemented by an infrared detector or a digital camera. The distance sensor 15 is preferably disposed in the same plane as the three-dimensional image display 11. The light source signal S1 emitted by the distance sensor 15 passes through the viewing environment 20 to the position of the viewer 40. The light source signal S1 is then reflected by the viewer 40 and received by the distance sensor 15 again. In this way, by detecting the time lag between the emission and the reflection of the light source signal S1, the position of the viewer 40 and, thus, the viewing distance L can be calculated.

Furthermore, as will be appreciated by those of ordinary skill in the art, the first luminosity value B1 of the three-dimensional image 30 may also be produced by a screen value or a luminescence time of the three-dimensional image display 11 apart from being produced by a backlight brightness of the three-dimensional image display 11.

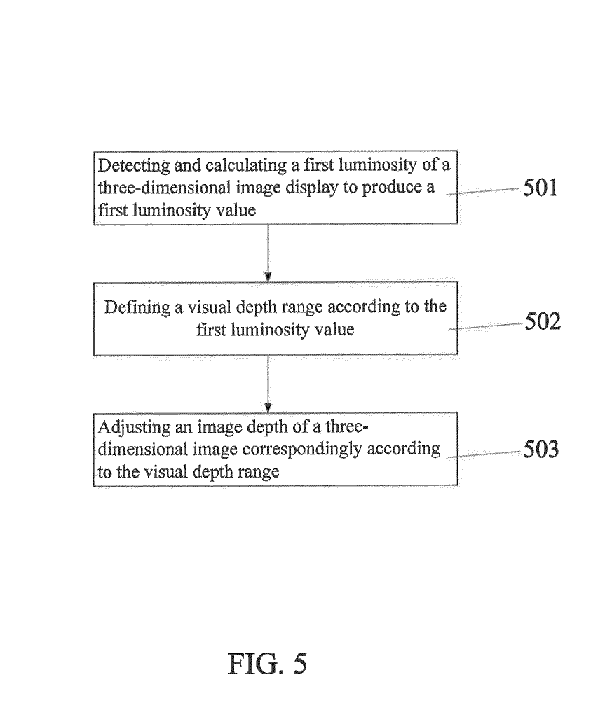

A method for adjusting a three-dimensional image of the present invention will be described hereinbelow with reference to the schematic structural view of the three-dimensional image adjusting device 1 shown in FIG. 3 and a flowchart diagram shown in FIG. 5.

Firstly, with reference to both FIG. 3 and step 501 of FIG. 5, a first luminosity B of the three-dimensional image display 11 is detected and calculated to produce a first luminosity value B1 in step 501. Then, as shown in step 502, a visual depth range V1 is defined according to the first luminosity value B1. Finally, as shown in step 503, an image depth D1 of the three-dimensional image 30 is adjusted correspondingly according to the visual depth range V1.

When the first luminosity value B1 increases, the image processor 14 adjusts the image depth D1 correspondingly to enhance the effect of the image depth D1. On the contrary, when the first luminosity value B1 is getting lower, the image processor 14 adjusts the image depth D1 correspondingly to decrease the effect of the image depth D1.

With reference to the embodiment of FIG. 4, a second luminosity value B2 is produced according to the environment luminosity E, preferably in step 502, and the visual depth range is determined by detecting both the first luminosity value B1 and the second luminosity value B2.

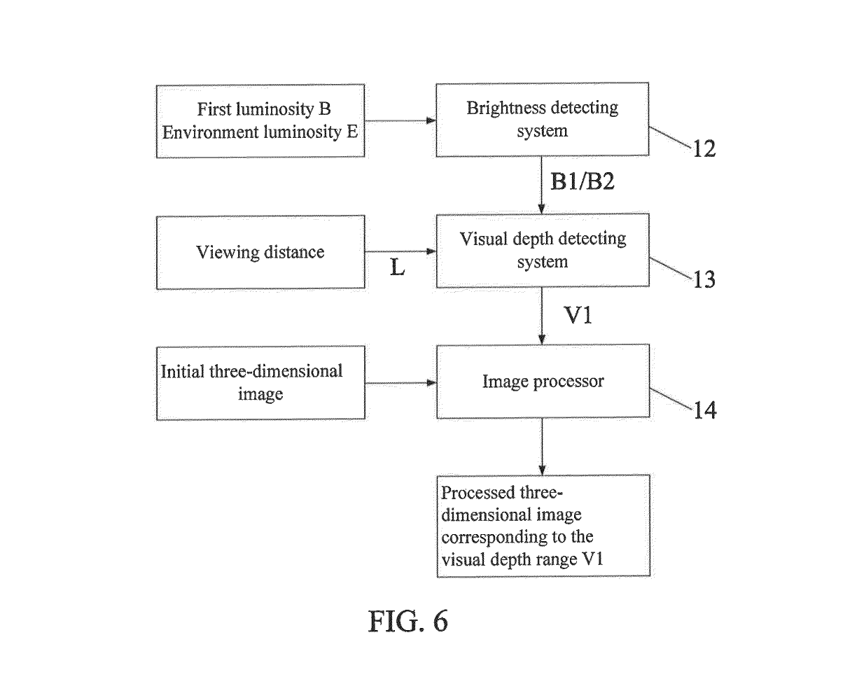

FIG. 6 is a block diagram of a three-dimensional image adjusting device according to an embodiment of the present invention. The brightness detecting system 12 produces the first luminosity value B1 and the second luminosity value B2 according to the first luminosity B and the environment luminosity E, and provides the first luminosity value B1 and the second luminosity value B2 to the visual depth detecting system 13. The visual depth detecting system 13 determines the visual depth range V1 according to the first luminosity value B1 and the second luminosity value B2 as well as the viewing distance L. Then, the image processor 14 processes the initial three-dimensional image by adjusting its image depth according to the visual depth range V1 to produce a processed three-dimensional image corresponding to the visual depth range V1.

It should be appreciated that in this embodiment, the viewing distance L is one of the parameters used by the image processor 14 to finely adjust the image depth D1. The influence of the viewing distance L on the image depth D1 can be defined according to a corresponding table created from medical average values or experimental statistics. However, this is not intended to limit the present invention.

According to the above descriptions, the three-dimensional image adjusting device disclosed in the present invention is adapted to adjust the image depth of a three-dimensional image correspondingly by respectively detecting such information as the first luminosity of the three-dimensional image display, the second luminosity of the viewing environment and the viewing distance between the viewer and the three-dimensional image display. In this way, the image depth is always kept within a comfortable region of viewing angles of the viewer's two eyeballs to make the viewing of the three-dimensional image comfortable. Thereby, a comfortable 3D viewing effect can be obtained at a low cost without changing the structure of the display.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended,

What is claimed is:

1. A three-dimensional image adjusting device utilized in a viewing environment, comprising:
a three-dimensional image display tier producing a three-dimensional image with an image depth, and the three-dimensional image display emitting a first luminosity;
a brightness detecting system for detecting and calculating the first luminosity to produce a first luminosity value;
a visual depth detecting system for defining a visual depth range according to the first luminosity value; and
an image processor for adjusting the image depth of the three-dimensional image correspondingly according to the visual depth range;
wherein when the first luminosity value is getting higher, the visual depth range increases correspondingly.

2. The three-dimensional image adjusting device as claimed in claim 1, wherein the brightness detecting system further detects and calculates an environment luminosity of the viewing environment to produce a second luminosity value, and the visual depth detecting system defines the visual depth range according to the first luminosity value and the second luminosity value.

3. The three-dimensional image adjusting device as claimed in claim 2, wherein the image processor adjusts the image depth of the three-dimensional image correspondingly according to the visual depth range.

4. The three-dimensional image adjusting device as claimed in claim 1, further comprising a distance sensor for detecting the viewing distance between at least one viewer and the three-dimensional image display.

5. The three-dimensional image adjusting device as claimed in claim 4, wherein the image processor adjusts the image depth correspondingly according to the viewing distance and the visual depth range.

6. The three-dimensional image adjusting device as claimed in claim 4, wherein the distance sensor is an infrared photo detector or a digital camera.

7. The three-dimensional image adjusting device as claimed in claim 1, wherein the first luminosity value is produced by the backlight brightness of the three-dimensional image display.

8. The three-dimensional image adjusting device as claimed in claim 1, wherein the first luminosity value is produced by the screen values or the luminescence time of the three-dimensional image display.

9. A method for adjusting a three-dimensional image of a three-dimensional image display in a viewing environment, comprising the following steps:
(a) detecting and calculating a first luminosity of the three-dimensional image display to produce a first luminosity value;
(b) defining a visual depth range according to the first luminosity value; and
(c) adjusting an image depth of a three-dimensional image produced by the three-dimensional image display correspondingly according to the visual depth range.

10. The method as claimed in claim 9, wherein the step (a) further comprises:
detecting an environment luminosity of the viewing environment to produce a second luminosity value.

11. The method as claimed in claim 9, wherein the step (b) further comprises:
detecting the visual depth range according to the first luminosity value and the second luminosity value.

12. The method as claimed in claim 9, further comprising the following steps:
(d) detecting the viewing distance between at least one viewer and the three-dimensional image display; and
(e) adjusting the image depth correspondingly according to the viewing distance.

13. The method as claimed in claim 9, wherein the step (c) further comprises:
(c1) increasing the visual depth range to enhance the effect of the image depth when the first luminosity value is getting higher; and
(c2) reducing the visual depth range to decrease the effect of the image depth when the first luminosity value is getting lower.
